(19) United States
(12) Patent Application Publication
(10) Pub. No.: US 2024/0370718 A1
(43) Pub. Date: Nov. 7, 2024

(54) SYSTEMS AND METHODS FOR MULTI-MODAL LANGUAGE MODELS

(71) Applicant: Salesforce, Inc., San Francisco, CA (US)

(72) Inventors: Artemis Panagopoulou, San Francisco, CA (US); Le Xue, Mountain View, CA (US); Ning Yu, Palo Alto, CA (US); Junnan Li, Singapore (SG); Dongxu Li, Singapore (SG); Silvio Savarese, Palo Alto, CA (US); Shafiq Rayhan Joty, San Jose, CA (US); Ran Xu, Mountain View, CA (US); Caiming Xiong, Menlo Park, CA (US); Juan Carlos Niebles Duque, Mountain View, CA (US)

(21) Appl. No.: 18/400,477

(22) Filed: Dec. 29, 2023

Related U.S. Application Data
(60) Provisional application No. 63/500,551, filed on May 5, 2023.
(60) Provisional application No. 63/586,073, filed on Sep. 28, 2023.

(51) Int. Cl. G06N 3/08; G06N 3/0455

(52) U.S. Cl. CPC G06N 3/08; G06N 3/0455

(57) ABSTRACT

Embodiments described herein provide a method of generating a multi-modal task output to a text instruction relating to inputs of multiple different modalities (e.g., text, audio, video, 3D). The method comprises receiving, via a data interface, a first input of a first modality, a second input of a second modality and the text instruction relating to the first and the second inputs; encoding, by a first multimodal encoder adapted for the first modality, the first input of the first modality into a first encoded representation conditioned on the text instruction; encoding, by a second multimodal encoder adapted for the second modality, the second input of the second modality into a second encoded representation conditioned on the text instruction; and generating, by a neural network based language model, the multi-modal task output based on an input combining the first encoded representation, the second encoded representation, and the text instruction.

### CROSS REFERENCE(S)

The instant application is a nonprovisional of and claim priority under 35 U.S.C. 119 to U.S. provisional application No. 63/500,551, filed May 5, 2023, and U.S. provisional application No. 63/586,073, filed Sep. 28, 2023, which are hereby expressly incorporated by reference herein in their entirety.

The instant application is related to co-pending and commonly-owned U.S. nonprovisional application Ser. No. 18/505,982, filed Nov. 9, 2023, which is hereby expressly incorporated herein by reference in its entirety.

### TECHNICAL FIELD

The embodiments relate generally to machine learning systems for multi-modal language models, and more specifically to systems and methods for training and inference of multi-modal language models.

### BACKGROUND

Language models are trained to take an input prompt and output a text response. Vision-Language models are trained to take both images and text inputs and output text. For example, the text input may include a user question about the image input, e.g., “what is the red dot next to the head of the dog,” and the output text would be a response to the question based on the image. Existing systems may be designed for a single modality in addition to a text prompt (e.g., images), therefore there is a need for systems and methods for multi-modal language models for responding to instructions.

### BRIEF DESCRIPTION OF THE DRAWINGS

FIG. 1A is a simplified diagram illustrating a multi-modal instruction model framework according to some embodiments.

FIG. 1B is a simplified diagram illustrating a cross-modal instruction model framework according to some embodiments.

FIG. 2 is a simplified diagram illustrating an exemplary multimodal encoder, according to some embodiments.

FIG. 3 is a simplified diagram illustrating a training framework for a multi-modal instruction model according to some embodiments.

FIG. 4A is a simplified diagram illustrating a computing device implementing the multi-modal instruction model framework described in FIGS. 1A-3, according to some embodiments.

FIG. 4B is a simplified diagram illustrating a neural network structure, according to some embodiments.

FIG. 5 is a simplified block diagram of a networked system suitable for implementing the multi-modal instruction model framework described in FIGS. 1A-3 and other embodiments described herein.

FIG. 6 is an example logic flow diagram illustrating a method of multi-modal instruction responding based on the framework shown in FIGS. 1A-3, according to some embodiments.

FIG. 7 illustrates exemplary multi-modal instruction responses, according to some embodiments.

FIGS. 8-12 provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

### Overview

Language models are trained to take an input prompt and output a text response. Vision-Language models are trained to take both images and text inputs and output text. For example, the text input may include a user question about the image input, e.g., “what is the red dot next to the head of the dog,” and the output text would be a response to the question based on the image. Traditionally, an encoder may need to be pretrained with a corpus of data samples of a specific modality to handle tasks relating to one or more particular modalities.

In view of the need for systems and methods for multi-modal language models, embodiments herein provide a multi-modal language model that is trained to handle tasks containing an ad-hoc number of modalities. Inputs of different modalities (such as image, video, text, audio, programming language, and/or the like) may be input to a multimodal encoder together with a text instruction, allowing the multimodal encoder to produce an instruction-aware encoding of the input. For example, an image showing a dog and a cat may be input to the multimodal encoder together with an instruction “what color is the dog's fur?”. Based on the instruction, the multimodal encoder may produce a vector representation of the image using cross attention to the instruction such that the resulting representation contains more information relevant/focused on the dog portion of the image. This focused representation is used as an input together with the instruction to an LLM which generates a response output to the instruction based on the image.

To accommodate different modalities, separate multimodal encoders may be trained, each one specific to a certain modality (e.g., image, video, audio, 3D) and the outputs of each may be used together to form a prompt for the LLM, where each encoded input may be prepended with an indication of its modality. For example, a prompt for the LLM may be: “{audio modality}<instruction-aware encoding of audio input> {image modality} <instruction-aware encoding of image input} does the audio or the image demonstrate a child playing?” In some embodiments, each multimodal encoder is trained as a multimodal encoder “Q-Former” as described in U.S. patent application Ser. No. 18/505,982, incorporated herein by reference.

Training of the models may be performed in multiple stages. For example, in a first pre-training stage, a multimodal encoder may be trained to generate a latent representation of an input of its specified modality (e.g., image) and associated text input. For example, this may be done as the vision-language (multimodal) representation learning of the multimodal encoder (i.e., Q-Former) described in U.S. patent application Ser. No. 18/505,982, incorporated herein by reference. In this pre-training stage, in the example of an image modality, vision-language (multimodal) representation learning enforces the multimodal encoder to be trained to generate a representation that is most relevant to the input text.

In a second pre-training stage, modality-to-language (e.g., vision-to-language) generative learning may be performed by connecting the output of the updated multimodal encoder to an LLM that generates an output text. The multimodal encoder is again trained such that its output representation can be interpreted by the LLM. In some embodiments, during the second stage, only the multimodal encoder and the queries are updated while other encoders and the language model are frozen. Additional details of vision-language (multimodal) generative learning is described in U.S. patent application Ser. No. 18/505,982, incorporated herein by reference.

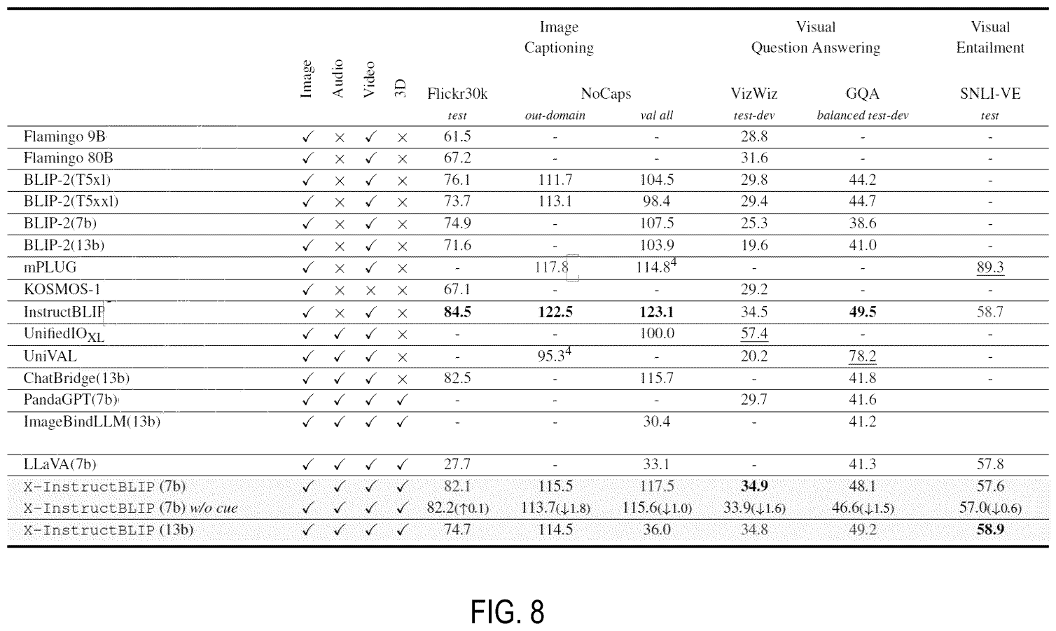

Embodiments described herein provide a number of benefits. For example, a variety of available LLMs such as GPT-3.5, GPT-4.0, etc., may be used with the methods described herein, as the input prompt for the various LLMs may easily be replaced with a prompt that includes the various modality-specific inputs without modifying parameters of the base LLM itself. This may reduce the amount of training/fine-tuning required to create a final model. Improved accuracy of the output text can be achieved for various different tasks as shown in FIGS. 8-12, at least due to improved latent representations of inputs of the different modalities. The latent representations, since they are instruction-aware, are able to contain more relevant information using less memory. A capability of a model described herein that receives inputs of multiple modalities, is reasoning across those different modalities, even when each modality multimodal encoder is trained individually. Therefore, neural network technology in performing cross-modality language tasks that involves various modality data such as audio, video, image, programming language, and/or the like is improved.

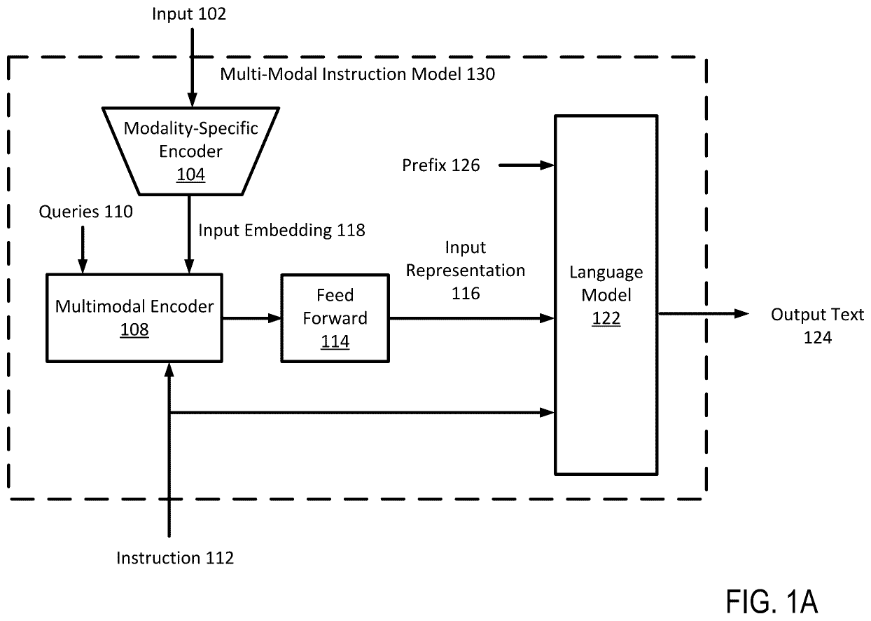

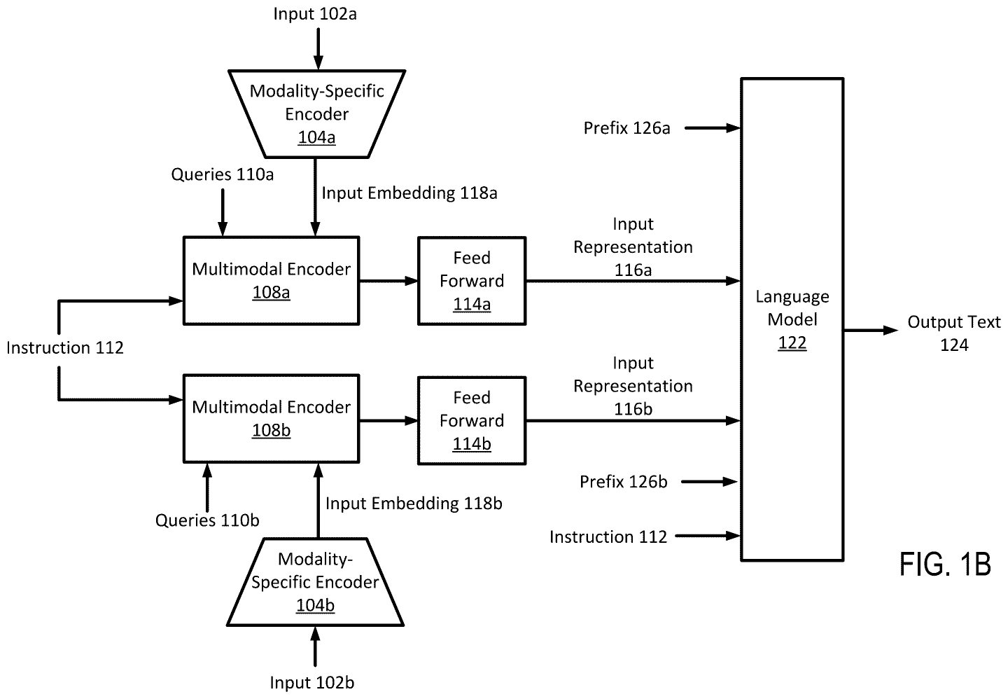

FIG. 1A is a simplified diagram illustrating a multi-modal instruction model framework according to some embodiments. Multi-modal instruction model 130 comprises a language model 122 and a multimodal encoder 108 which aids in the generation of an input representation 116 for language model 122. Language model 122 may be a large language model (LLM). For example, language model 122 may be a FlanT5 model as described in Chung et al., Scaling instruction-finetuned language models, arXiv:2210.11416, 2022. Multi-modal instruction model 130 takes an input 102, and an instruction 112, and based on those inputs generates an output text 124. For example, an input 102 may be an image of various vegetables and other ingredients on a table. The instruction 112 may be “Can you tell me about this image in detail?”. With these exemplary inputs, multi-modal instruction model 130 would generate an output text such as: “The image depicts a collection of various vegetables including carrots, cucumbers, tomatoes, and nuts arranged on a table. There are several jars filled with different types of ingredients, such as peanuts, cashews, and pumpkin seeds. These ingredients are likely to be part of a healthy meal or snack”. Input 102 may be an input of a different modality, for example audio, video, 3d model, etc. Multi-modal instruction model 130 may be trained for a specific modality.

The multimodal encoder 108 may comprise a lightweight transformer structure which employs a set of learnable queries 110 to extract features from the frozen modality-specific encoder 104. In other words, the multimodal encoder 108 acts as an information bottleneck between the frozen modality-specific encoder 104 and the frozen language model 122, where it feeds the most useful features from input 102 for the language model 122 to output the desired text. For example, the multimodal encoder 108 may contain 188M parameters, which is relatively much fewer parameters to update compared to an LLM or image encoder.

Input 102 may be encoded by a modality-specific encoder 104 into an input embedding 118, which may be a vector representation of the input 102. In some embodiments, modality-specific encoder 104 may be a pretrained image encoder which extracts generic image features. In some embodiments, modality-specific encoder 104 may be a pretrained audio encoder which extracts generic audio features. Modality-specific encoder 104 may be specific to a variety of different modalities. Instruction 112 may be encoded by a text encoder into a text feature vector. The input embedding 118 and text feature vector may be input to multimodal encoder 108. Multimodal encoder 108 may be a query transformer (“Q-Former”) as described in U.S. patent application Ser. No. 18/505,982, incorporated herein by reference. Multimodal encoder 108 may also take queries 110 as an input. Queries 110 may be randomly initialized vectors which may be tuned as part of the training process. Multimodal encoder 108 generates a vector representation of the input (e.g., instruction-aware input representation) by using the instruction 112 to attend to the portions of input 102 most relevant to the instruction 112. In some embodiments, a feed forward neural network further updates the vector representation of the subject, providing input representation 116 in a format more suitable for language model 122.

Input representation 116 and instruction 112 may be combined to generate the prompt for language model 122. In some embodiments, prefix 126 may be used to indicate the modality of input 102. For example, if input 102 is an image, prefix 126 may be “Modality-Image”. Language model 122 may then generate an output text 124, a multi-modal task output, based on the prompt.

Training of the multi-modal instruction model 130 may be performed in multiple stages. In a first pre-training stage, multimodal encoder 108 may be trained to generate a latent representation of an input 102 and associated instruction 112. Specifically, this may be done as the vision-language (multimodal) representation learning of the multimodal encoder (i.e., Q-Former) described in U.S. patent application Ser. No. 18/505,982, incorporated herein by reference. In this pre-training stage, representation learning enforces the multimodal encoder to learn to generate a representation that is most relevant to the instruction 112.

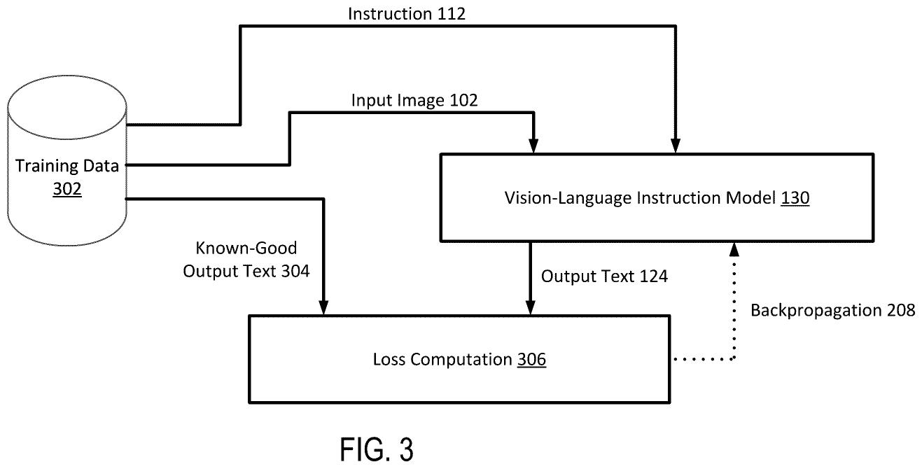

In a second pre-training stage, modality-to-language (e.g., vision-to-language) generative learning is performed by connecting the output of the updated multimodal encoder 108 to an LLM (e.g., language model 122) that generates an output text 124. The multimodal encoder 108 is again trained such that its output representation can be interpreted by the LLM. In some embodiments, during the second stage, only the multimodal encoder 108 and the queries 110 are updated while the modality-specific encoder 104 and the language model 122 are frozen. Additional details of modality-language (e.g., vision-language) generative learning at stage 102 is described in U.S. patent application Ser. No. 18/505,982, incorporated herein by reference. A third pre-training stage (instruction tuning) is described with respect to FIG. 3.

FIG. 1B is a simplified diagram illustrating a cross-modal instruction model framework according to some embodiments. In some embodiments, the framework in FIG. 1B is a combination of multiple modality-specific models as described in FIG. 1A, with separate encoders, but using a shared instruction 112 and language model 122, which allows for cross-modality reasoning to be performed. For example, an instruction 112 may be used to ask a question about both an audio input and an image input, and output text 124 may be a response to the question which takes into account both the input modalities. In some embodiments, cross-modality reasoning may be performed without specifically training for cross-modality reasoning, and training each modality individually.

In some embodiments, input 102a is an input of a first modality (e.g., image) which is input to modality-specific encoder 104a (e.g., a pre-trained image encoder) to provide input embedding 118a. Multimodal encoder 108a, which may be trained on the specific modality associated with input 102a, is given input embedding 118a, instruction 112, and queries 110a (which may be trained jointly with multimodal encoder 108a as described in FIG. 1A) to provide input representation 116a. In some embodiments, feed forward 114a modifies the direct output of multimodal encoder 108a via a trained neural network based model.

Similarly, input 102b is an input of a second modality (e.g., audio) which is input to modality-specific encoder 104b (e.g., a pre-trained audio encoder) to provide input embedding 118b. Multimodal encoder 108b, which may be trained on the specific modality associated with input 102b, is given input embedding 118b, instruction 112, and queries 110b (which may be trained jointly with multimodal encoder 108b as described in FIG. 1A) to provide input representation 116b. In some embodiments, feed forward 114b modifies the direct output of multimodal encoder 108b via a trained neural network based model.

Input representations 116a and 116b, and instruction 112 may be input to language model 122 to generate output text 124. In some embodiments, prefix 126a and/or prefix 126b are also input to language model 122 as an indication of the modalities associated with input representations 116a and 116b respectively. Additional fixed prompt language or tokens may also be included, such as a prompt template which may include few-shot training examples. For example, a combined prompt for language model 122 may be: “Respond to the following instruction based on the provided inputs with their indicated modalities:” <instruction 112> <prefix 126a> <input representation 116a> <prefix 126b> <input representation 116b>.

In some embodiments, the model of FIG. 1B is trained for a specific pair of modalities (e.g., image and audio). Prefixes 126a and 126b may therefore be fixed for a given model. In some embodiments, additional modalities may be included in a model by including additional modality-specific encoders 104, multimodal encoders 108, queries 110, and/or feed forwards 114. The input representations 116 of the various modalities may be associated with their own prefixes 126 and input to language model 122 along with the other modalities. In some embodiments, a model may be trained and configured with the ability to receive a number of modalities of inputs (e.g., 4 inputs of different modalities). In some embodiments, a subset of allowable modalities may be used at inference, and the model may be configured to ignore the unused inputs, and only input to language model 122 representations 116 and prefixes 126 for which inputs 102 of are provided. For example, a model may be trained and configured for any combination of audio, image, video, and 3D inputs. Such a model may, at inference, be given an instruction 112 an image, and a video, but no audio or 3D inputs. Such model may ignore the audio and 3D inputs, and may not run those specifics encoders associated with those inputs, but only perform inference using the encoders for the image and video inputs and provide their respective representations to language model 122 to produce output text 124.

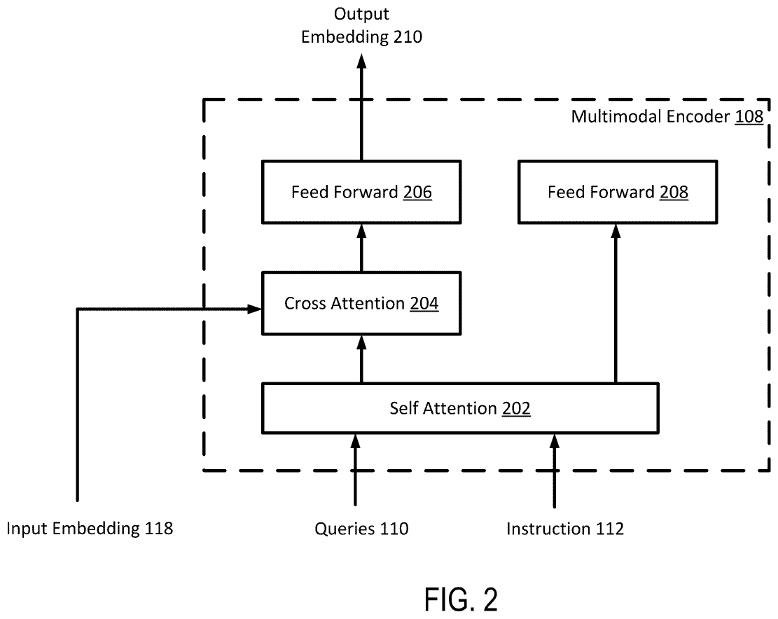

FIG. 2 is a simplified diagram illustrating an exemplary multimodal encoder 108, according to some embodiments. Multimodal encoder 108 may be a “query transformer” as described in U.S. patent application Ser. No. 18/505,982, incorporated herein by reference. The multimodal encoder 108 consists of two transformer submodules that share the same self-attention layer 202. An image transformer with cross attention 204 and feed forward 206 interacts with the frozen modality-specific encoder 104 by cross-attending input embedding 118 for visual feature extraction. A text transformer including feed forward 208 can function as both a text encoder and a text decoder.

In one embodiment, the input embedding 118 from the modality-specific encoder 104 is passed to cross attention 204 comprising a stack of transfer blocks. A fixed number of learnable query embeddings (“queries”) 110 are input to self attention 202. The queries 110 are also tunable, which may be deemed as parameters of the multimodal encoder 108 and updated with the multimodal encoder 108 during training.

The queries 110 interact with each other through self-attention layer 202 to produce self-attention outputs. In one implementation, the queries 110 may additionally interact with the instruction 112 through the same self-attention layer 202, e.g., via attention masking.

The self-attention outputs then interact with frozen input features, e.g., the input representation from the frozen modality-specific encoder 104, through cross-attention layers 204 to produce cross-attention outputs. In one implementation, the cross-attention layers 204 may be inserted every other transformer block.

The cross-attention outputs may be passed through a feed forward layer 206 that generates the output embedding 210 as a transformed input representation for the input 102. For example, 32 queries may be employed, where each query has a dimension of 768 (same as the hidden dimension of the multimodal encoder 108). The size of output embedding 210 (32×768) is much smaller than the size of frozen image features (e.g. 257×1024 in some embodiments).

On the other hand, the text transformer receives and encodes the input instruction 112. Specifically, text tokens in the instruction 112 interact with each other through self-attention layers 202 to produce self-attention outputs.

Different modality-language (e.g., vision-language) objectives are then adopted into forcing the queries 110 to extract information from the input representation that is most relevant to the text instruction 112. A feed forward layer 208 may then generate a text representation from the self-attention outputs. Depending on the training stage, instruction 112 may be another text input such as an image caption associated with input 102.

In one embodiment, the query representation (output embedding 210) and the text representation may further be used to compute different pre-training objectives that share the same input format and model parameters. Each objective employs a different attention masking strategy between queries and text to control their interaction. One set of objectives may be jointly used to update parameters of multimodal encoder 108, as described in U.S. patent application Ser. No. 18/505,982, incorporated herein by reference.

FIG. 3 is a simplified diagram illustrating a training framework for a multi-modal instruction model 130 according to some embodiments, which may be applied to a multi-modal instruction model which includes multiple different modality inputs as described in FIG. 1B. Specifically, FIG. 3 illustrates a pre-training stage of instruction tuning which may occur after the first pre-training stages described in FIG. 1A. In the instruction-tuning stage multimodal encoder 108 is trained to generate instruction-aware input representations. Feed forward 114, queries 110, and/or language model 122 may be jointly trained with multimodal encoder 108. The aim of this stage is for the model to learn to represent an input (e.g., image) in a way that efficiently represents the aspects of the input most relevant to an instruction 112. To accomplish this, training ground-truth input/output pairs may be used which include an input 102, an instruction 112, and a known-good output text 304.

In some embodiments, input representation 116 and instruction 112 may be combined by the use of a prompt template. The prompt template may be, for example, “<image> Based on the image, answer the following question with a short answer: [Question]” where <image> is the input representation 116 and [question] is a question associated with the image in a training dataset. In some embodiments, prompt templates are used to convert a dataset into an instruction dataset. For example, one dataset may have a set of images and related captions, and the template may be “<image> Write a short description for the image.” In this case, the caption is not used as the instruction, but rather only as the known-good output text 304 against which the generated output text 124 is compared. Similar prompt templates may be used for various other modalities.

The multi-modal instruction model 130 may be provided an input 102 including a subject, and an instruction 112 to generate an output text 124. The output text 124 may be compared to the known-good output text by loss computation 306. The loss computed by loss computation 306 may be used to update parameters of multi-modal instruction model 130 via backpropagation 308. In some embodiments, backpropagation 308 may update parameters of multimodal encoder 108, queries 110, and/or language model 122. Loss computation 306 may include, for example, a cross entropy loss function. The instruction tuning learning stage is not specific to a certain type of instruction, and is performed using a variety of inputs (e.g., a variety of images) with a variety of instructions. For training datasets with relatively uniform types of text (e.g., captions), variety may be injected to the training dataset by the use of randomly selected prompt templates which modify the prompt while maintaining the same semantics which would generate the expected output (e.g., caption).

When multiple training datasets are used where there are significant differences in the size of each dataset, mixing them uniformly could cause the multi-modal instruction model 130 to overfit smaller datasets and underfit larger datasets. To mitigate the problem, datasets may be sampled with probabilities proportional to the square root of their sizes (i.e., the number of samples). For example, given D datasets with sizes {S₁, S₂, . . . , S_{D}}, the probability of a data sample being selected from a dataset d during training may be

$${p}_{d} = \frac{\sqrt{{S}_{d}}}{{\sum }_{i = 1}^{D} \sqrt{{S}_{i}}}$$

After the instruction tuning training stage, zero-shot inference may be performed using a pair of an input 102 and instruction 112. However, better performance may be achieved in some circumstances with an additional domain-specific fine-tuning stage. The fine-tuning stage may be performed similar to the instruction tuning learning stages, but using a dataset of a specific domain.

In some embodiments, the vocabulary of language model 122 may be restricted in certain situations. For example, when performing instruction tuning using a training sample from a dataset where the known-good output text is always “true” or “false”, it may be advantageous to limit the vocabulary of language model 122 to only those two words. In some embodiments, language model 122 is still prompted to generate an output text 124, then the log-likelihood for each word in the vocabulary is calculated, and the one with the highest value is used as the final prediction.

In some embodiments, multiple inputs of a single modality (e.g., multiple images) may be input to multimodal encoder 108 for a single instruction, and the resulting instruction-aware input representations 116 for that modality may be concatenated together, averaged, or otherwise combined. For example, when a video is desired to be used as input, a number of successive frames from the video may be input as images to modality-specific encoder 104 and subsequently multimodal encoder 108, and the resulting instruction-aware input representations 116 may be concatenated. This preserves the changes in the images over the different frames of the video. In some embodiments, for a model that accepts multiple input modalities, varying amounts of inputs of each modality may be used, with the inputs from each modality having their respective input representations 116 combined.

In some embodiments, data augmentation may be performed to increase the amount of training data available. For example, a large dataset may exist with captions for images, but not instructions. A pretrained language model may be given image captions as an input and prompted to generate question-answer pairs based on the captions. The generated question-answer pairs may be used with the original images as a training triplet for one or more stages of training the model.

### Computer and Network Environment

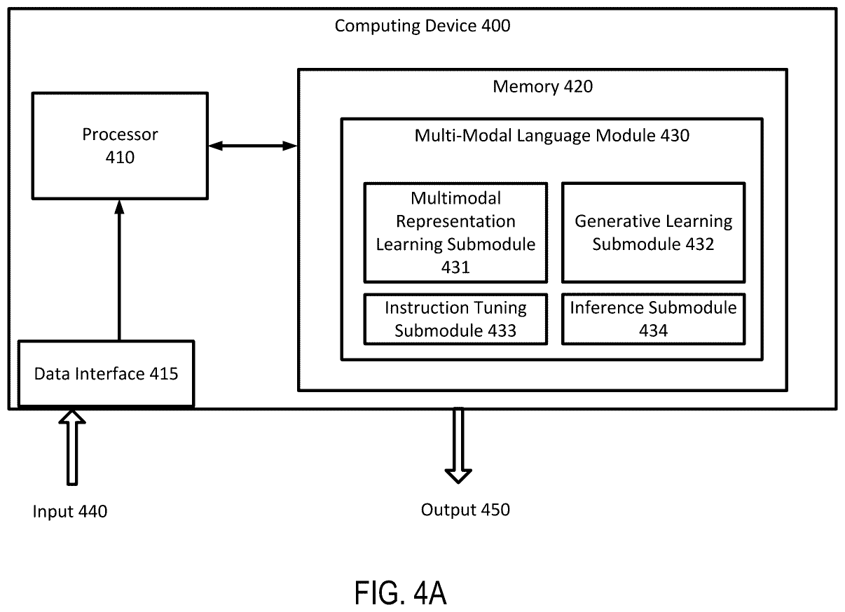

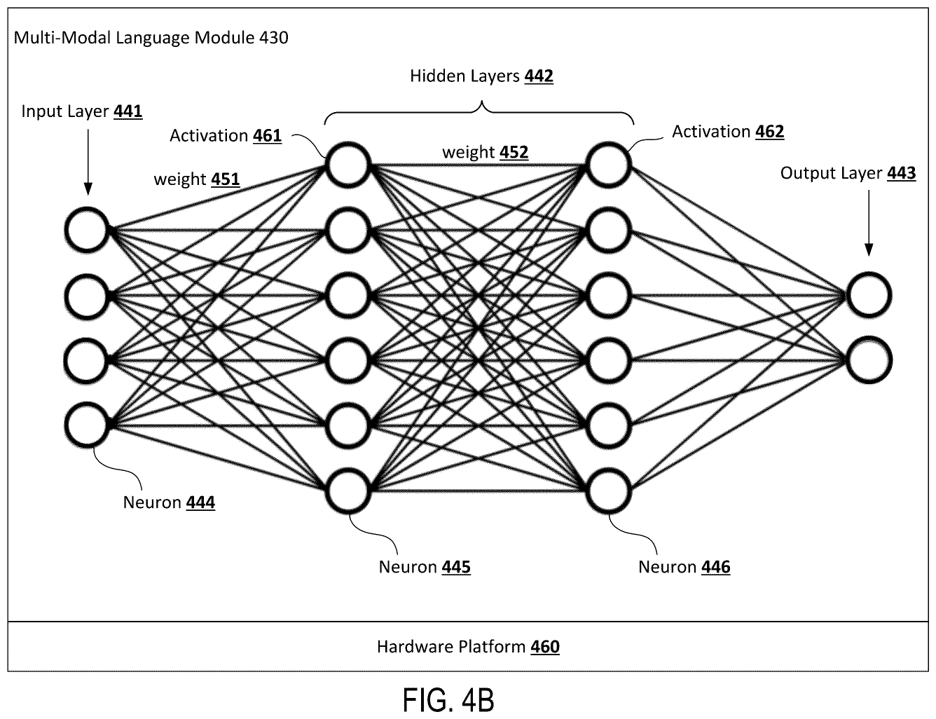

FIG. 4A is a simplified diagram illustrating a computing device 400 implementing the multi-modal instruction model framework described in FIGS. 1A-3, according to some embodiments. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for multi-modal language model 430 that may be used to implement and/or emulate the systems and models, and/or to implement any of the methods described further herein. multi-modal language model 430 may receive input 440 such as an input training data (e.g., input images, instructions, and known-good responses) via the data interface 415 and generate an output 450 which may be a text response.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as an image and/or instruction, from a user via the user interface.

In some embodiments, the multi-modal language model 430 is configured to generate an output text based on an input image and an instruction associated with the input image. The multi-modal language model 430 may further include multimodal representation learning submodule 431. Multimodal representation learning submodule 431 may be configured to train a multimodal encoder (e.g., multimodal encoder 108) to generate a vector representation of an input of a specific modality based on an associated text as described in FIG. 1A. The multi-modal language model 430 may further include generative learning submodule 432. Generative learning submodule 432 may be configured to further train the multimodal encoder (e.g., multimodal encoder 108) with a frozen language model to generate output text based on an input (e.g., input 102) and input text (e.g., instruction 112) as described in FIG. 1A. The multi-modal language model 430 may further include instruction-tuning submodule 433. Instruction-tuning submodule 433 may be configured to train parameters of the multi-modal language model using training data of inputs of specific modalities, instructions, and known-good text outputs as described in FIG. 1A. The multi-modal language model 430 may further include inference submodule 434. Inference submodule 434 may be configured to generate an output text based on one or more inputs of one or more modalities and an instruction as described in FIGS. 1A-3.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 4B is a simplified diagram illustrating the neural network structure implementing the multi-modal language model 430 described in FIG. 4A, according to some embodiments. In some embodiments, the multi-modal language model 430 and/or one or more of its submodules 431-434 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A), such as encoded instructions. The number of nodes (neurons) in the input layer 441 may be determined by the dimensionality of the input data (e.g., the length of a vector representation of an instruction). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4A, the multi-modal language model 430 receives an input 440 of an image and/or instruction and transforms the input into an output 450 of an output text. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the multi-modal language model 430 and/or one or more of its submodules 431-434 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a feed-forward multi-layer perceptron, and/or the like.

In one embodiment, the multi-modal language model 430 and its submodules 431-434 may be implemented by hardware, software and/or a combination thereof. For example, the multi-modal language model 430 and its submodules 431-434 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

In one embodiment, the neural network based multi-modal language model 430 and one or more of its submodules 431-434 may be trained by iteratively updating the underlying parameters (e.g., weights 451, 452, etc., bias parameters and/or coefficients in the activation functions 461, 462 associated with neurons) of the neural network based on a loss function. For example, during forward propagation, the training data such as images, and instructions are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding known-good output text) from the training data, to compute a loss function that measures the discrepancy between the predicted output and the expected output. For example, the loss function may be cross entropy, MMSE, or another loss function. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

Parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen images and instructions of a variety of domains.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network (e.g., the multi-modal encoder 108) thus improves neural network technology in vision language tasks, such as captioning, question answering based on image content, and/or the like.

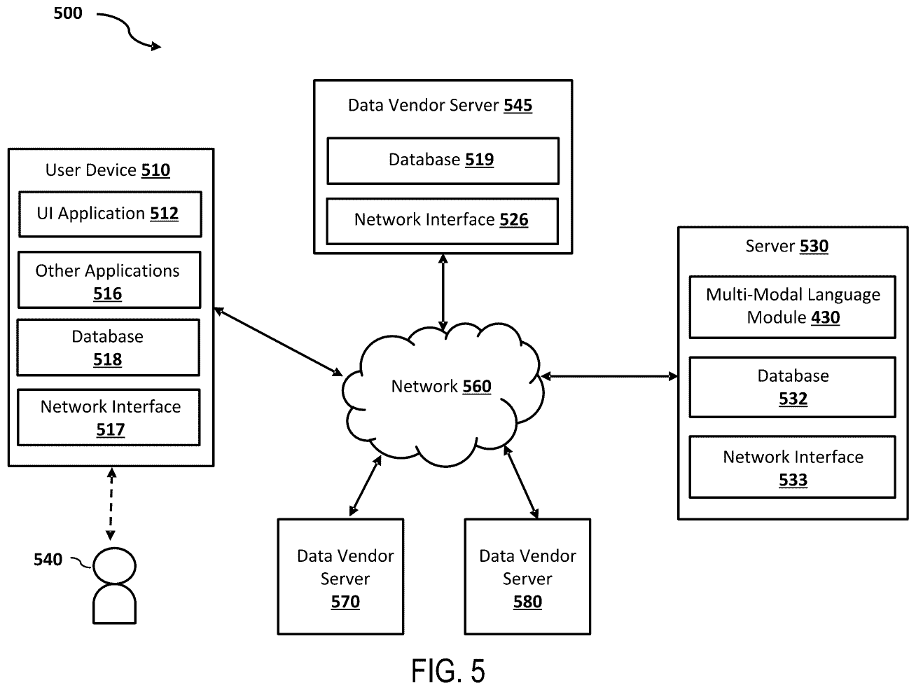

FIG. 5 is a simplified block diagram of a networked system 500 suitable for implementing the multi-modal instruction model framework described in FIGS. 1A-3 and other embodiments described herein. In one embodiment, system 500 includes the user device 510 which may be operated by user 540, data vendor servers 545, 570 and 580, server 530, and other forms of devices, servers, and/or software components that operate to perform various methodologies in accordance with the described embodiments. Exemplary devices and servers may include device, stand-alone, and enterprise-class servers which may be similar to the computing device 400 described in FIG. 4A, operating an OS such as a MICROSOFT® OS, a UNIX® OS, a LINUX® OS, or other suitable device and/or server-based OS. It can be appreciated that the devices and/or servers illustrated in FIG. 5 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 510, data vendor servers 545, 570 and 580, and the server 530 may communicate with each other over a network 560. User device 510 may be utilized by a user 540 (e.g., a driver, a system admin, etc.) to access the various features available for user device 510, which may include processes and/or applications associated with the server 530 to receive an output data anomaly report.

User device 510, data vendor server 545, and the server 530 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 500, and/or accessible over network 560.

User device 510 may be implemented as a communication device that may utilize appropriate hardware and software configured for wired and/or wireless communication with data vendor server 545 and/or the server 530. For example, in one embodiment, user device 510 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLER. Although only one communication device is shown, a plurality of communication devices may function similarly.

User device 510 of FIG. 5 contains a user interface (UI) application 512, and/or other applications 516, which may correspond to executable processes, procedures, and/or applications with associated hardware. For example, the user device 510 may receive a message indicating output text from the server 530 and display the message via the UI application 512. In other embodiments, user device 510 may include additional or different modules having specialized hardware and/or software as required.

In various embodiments, user device 510 includes other applications 516 as may be desired in particular embodiments to provide features to user device 510. For example, other applications 516 may include security applications for implementing client-side security features, programmatic client applications for interfacing with appropriate application programming interfaces (APIs) over network 560, or other types of applications. Other applications 516 may also include communication applications, such as email, texting, voice, social networking, and IM applications that allow a user to send and receive emails, calls, texts, and other notifications through network 560. For example, the other application 516 may be an email or instant messaging application that receives a prediction result message from the server 530. Other applications 516 may include device interfaces and other display modules that may receive input and/or output information. For example, other applications 516 may contain software programs for asset management, executable by a processor, including a graphical user interface (GUI) configured to provide an interface to the user 540 to view images and/or text.

User device 510 may further include database 518 stored in a transitory and/or non-transitory memory of user device 510, which may store various applications and data and be utilized during execution of various modules of user device 510. Database 518 may store user profile relating to the user 540, predictions previously viewed or saved by the user 540, historical data received from the server 530, and/or the like. In some embodiments, database 518 may be local to user device 510. However, in other embodiments, database 518 may be external to user device 510 and accessible by user device 510, including cloud storage systems and/or databases that are accessible over network 560.

User device 510 includes at least one network interface component 517 adapted to communicate with data vendor server 545 and/or the server 530. In various embodiments, network interface component 517 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 545 may correspond to a server that hosts database 519 to provide training datasets including input images, audio, video, 3D, other modalities, instructions, and known-good output text to the server 530. The database 519 may be implemented by one or more relational database, distributed databases, cloud databases, and/or the like.

The data vendor server 545 includes at least one network interface component 526 adapted to communicate with user device 510 and/or the server 530. In various embodiments, network interface component 526 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 545 may send asset information from the database 519, via the network interface 526, to the server 530.

The server 530 may be housed with the multi-modal language model 430 and its submodules described in FIG. 4A. In some implementations, multi-modal language model 430 may receive data from database 519 at the data vendor server 545 via the network 560 to generate output text. The generated output text may also be sent to the user device 510 for review by the user 540 via the network 560.

The database 532 may be stored in a transitory and/or non-transitory memory of the server 530. In one implementation, the database 532 may store data obtained from the data vendor server 545. In one implementation, the database 532 may store parameters of the multi-modal language model 430. In one implementation, the database 532 may store previously generated vectors or outputs, and the corresponding input feature vectors.

In some embodiments, database 532 may be local to the server 530. However, in other embodiments, database 532 may be external to the server 530 and accessible by the server 530, including cloud storage systems and/or databases that are accessible over network 560.

The server 530 includes at least one network interface component 533 adapted to communicate with user device 510 and/or data vendor servers 545, 570 or 580 over network 560. In various embodiments, network interface component 533 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 560 may be implemented as a single network or a combination of multiple networks. For example, in various embodiments, network 560 may include the Internet or one or more intranets, landline networks, wireless networks, and/or other appropriate types of networks. Thus, network 560 may correspond to small scale communication networks, such as a private or local area network, or a larger scale network, such as a wide area network or the Internet, accessible by the various components of system 500.

### Example Work Flows

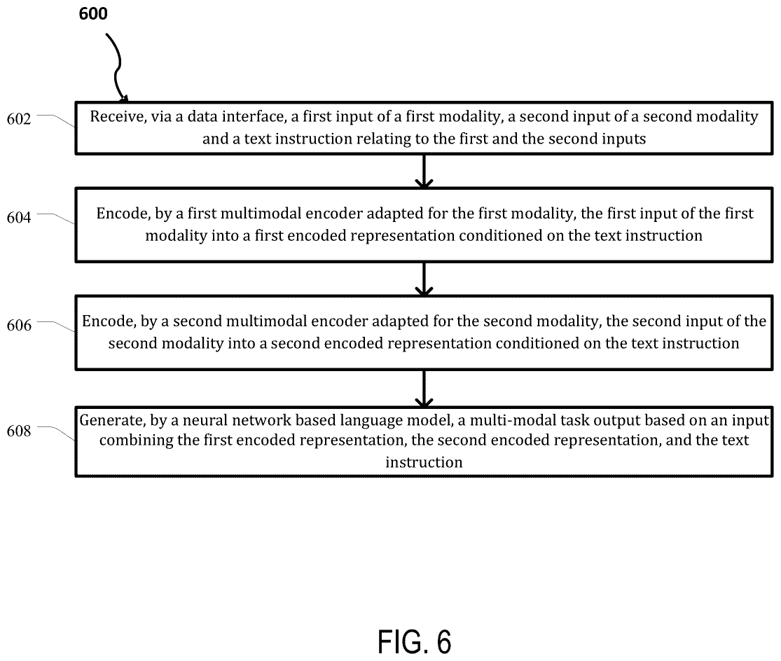

FIG. 6 is an example logic flow diagram illustrating a method of multi-modal instruction responding based on the framework shown in FIGS. 1A-3, according to some embodiments. One or more of the processes of method 600 may be implemented, at least in part, in the form of executable code stored on non-transitory, tangible, machine-readable media that when run by one or more processors may cause the one or more processors to perform one or more of the processes. In some embodiments, method 600 corresponds to the operation of the multi-modal language model 430 (e.g., FIGS. 4A and 5) that generates responses to multi-modal inputs.

As illustrated, the method 600 includes a number of enumerated steps, but aspects of the method 600 may include additional steps before, after, and in between the enumerated steps. In some aspects, one or more of the enumerated steps may be omitted or performed in a different order.

At step 602, a system (e.g., computing device 400 or server 530) receives, via a data interface (e.g., data interface 415 or network interface 533), a first input of a first modality (e.g., input 102a), a second input of a second modality (e.g., input 102b), and a text instruction (e.g., instruction 112) relating to the first and second inputs. The first and second modalities may be any of a number of different modalities, for example audio, video, text, images, 3D. Modalities may also be more specific, for example images of a certain type (e.g., relief maps, canny edge, sketch drawings, photographs, etc.). In some embodiments, the first and second modalities are different from each other (e.g., audio and image).

At step 604, the system encodes, via a first multimodal encoder (e.g., multimodal encoder 108a) adapted for the first modality, the first input of the first modality into a first encoded representation (e.g., input representation 116a) conditioned on the text instruction. Before the multimodal encoders, each input of each modality may be encoded by a modality-specific encoder, and the output of the modality-specific encoders may be the input to the multimodal encoders. Further, the encoding the first input of the first modality into the first encoded representation may include generating, by the first multimodal encoder, the first encoded representation based on cross-attending the first vector representation to the text instruction. Encoding the first input of the first modality into the first encoded representation may further include cross-attending a plurality of vector queries e.g., queries 110) to the text instruction (e.g., via self-attention 202).

At step 606, the system encodes, by a second multimodal encoder (e.g., multimodal encoder 108b) adapted for the second modality, the second input of the second modality into a second encoded representation (e.g., input representation 116b) conditioned on the text instruction.

At step 608, the system generates, by a neural network based language model (e.g., language model 122), the multi-modal task output (e.g., output text 124) based on an input combining the first encoded representation, the second encoded representation, and the text instruction. The generating the multi-modal task output may be further based on a first prefix indicating the first modality and a second prefix indicating the second modality.

In some embodiments, one or more additional modalities may be included with their own respective inputs of one or more modalities, multimodal encoders, etc. The system may encode, by respective multimodal encoders adapted for the one or more additional modalities, the one or more additional inputs of one or more additional modalities into additional encoded representations conditioned on the text instruction. The generating the multi-modal task output may be further based on the additional encoded representations.

### Example Results

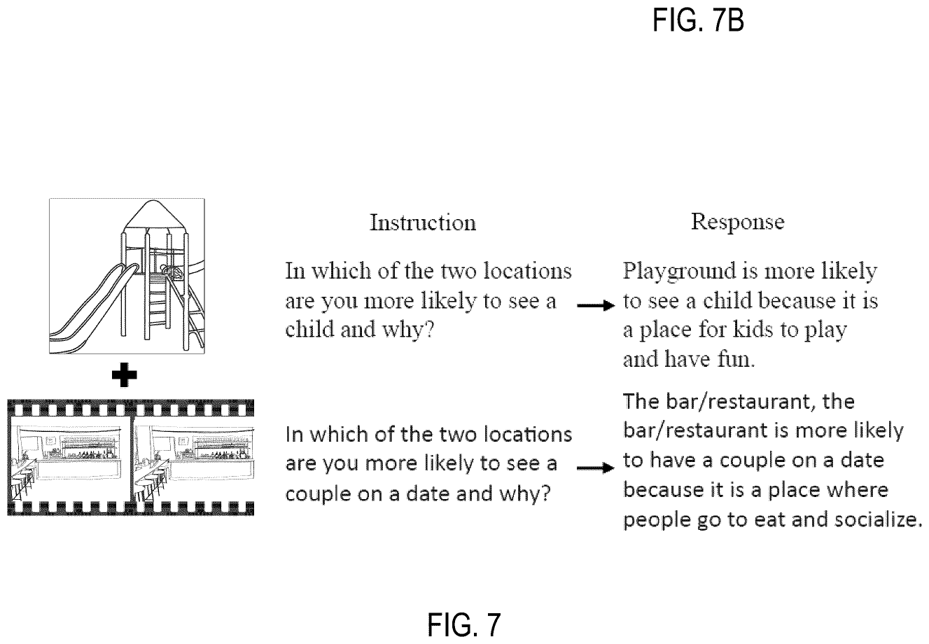

FIG. 7 illustrates exemplary multi-modal instruction responses, according to some embodiments. In the illustrated example, two inputs are provided of different modalities (image and video). The image shows a playset and the video shows a bar scene. Two examples of instructions and generated responses are provided. In the first example, the instruction is “In which of the two locations are you more likely to see a child and why” with the generated response of “Playground is more likely to see a child because it is a place for kids to play and have fun.” In the second example, the instruction is “In which of the two locations are you more likely to see a couple on a date and why?” with the generated response of “The bar/restaurant, the bar/restaurant is more likely to have a couple on a date because it is a place where people go to eat and socialize.” These examples illustrate the cross-modality reasoning that is possible when using a model such as the one shown in FIG. 2A.

A wide variety of instructions may be used to provide responses about a provided one or more inputs of various modalities. Types of instructions may include, for example, captioning, questions discriminating between inputs, questions related to both inputs, classification, etc.

FIGS. 8-12 represent exemplary test results using embodiments described herein. Model performance was evaluated across a range of single modality and multi-modal to text tasks, illustrating the versatility of models described herein. FIGS. 8-10 summarize the model's performance across image, audio and video, and 3D modalities. Embodiments of the model (e.g., as described in FIGS. 1A-5) may be referred to as X-InstructBLIP.

Benchmarks used for comparison include VizWiz as described in Bigham et al., Vizwiz: nearly real-time answers to visual questions, Proceedings of the 23rd annual ACM symposium on User interface software and technology, pp. 333-342, 2010; MSVD captioning as described in Chen and Dolan, Collecting highly parallel data for paraphrase evaluation, Proceedings of the 49th annual meeting of the association for computational linguistics: human language technologies, pp. 190-200, 2011; MSVD QA as described in Xu et al., Video question answering via gradually refined attention over appearance and motion, Proceedings of the 25th ACM international conference on Multimedia, pp. 1645-1653, 2017; ClothoV2 as described in Drossos et al., Clotho dataset, May 2021; Closed vocabulary classification as described in Li et al, Align before fuse: Vision and language representation learning with momentum distillation, Advances in neural information processing systems, 34:9694-9705, 2021; ModelNet40 as described in Chang et al., Shapenet: An information rich 3d model repository, arXiv: 1512.03012, 2015; and PointLLM as described in Xu et al., Pointllm: Empowering large language models to understand point clouds, arXiv: 2308.16911, 2023. Cross-modality benchmarks used include ChatBridge as described in Zhao et al., Chatbridge: Bridging modalities with large language model as a language catalyst, 2023; Music AVQA as described in Li et al., Learning to answer questions in dynamic audio-visual scenarios, Proceedings of the IEEE/CVF Conference on Computer Vision and Pattern Recognition, pp. 19108-19118, 2022; AVSD as described in Alamri et al., Audio visual scene-aware dialog (asvd) track for natural language generation in dstc7, DSTC7 at AAAI2019 Workship, volume 2, 2018; and VALOR as described in Chen et al., Valor: Vision-audio-language omni-perception pretraining model and dataset, 2023.

Baseline models used for comparisons include Flamingo as described in Alayrac et al., Flamingo: a visual language model for few-shot learning, Advances in Neural Information Processing Systems, 35:23716-23736, 2022; BLIP-2 as described in Li et al., Blip-2: Bootstrapping language-image pre-training with frozen image encoders and large language models, arXiv: 2301.12597, 2023; mPLUG as described in Li et al., mplug: Effective and efficient vision-language learning by cross-modal skip-connections, arXiv: 2205.12005, 2022; KOSMOS as described in Huang et al., Language is not all you need: Aligning perception with language models, 2023; InstructBLIP as described in Dai et al., Instructblip: Towards general-purpose vision-language models with instruction tuning, 2023; UnifiedIOXL as described in Lu et al., Unified-io: A unified model for vision, language, and multi-modal tasks, 2022; UniVAL as described in Shukor et al., Unified model for image, video, audio and language tasks, arXiv: 2307.16184, 2023; ChatBridge as described in Zhao et al., Chatbridge: Bridging modalities with large language model as a language catalyst, 2023; PandaGPT as described in Su et al., Pandagpt: One model to instruction-follow them all, arXiv: 2305.16355, 2023; and ImageBindLLM as described in Girdhar et al., Imagebind: One embedding space to bind them all, 2023.

For the image modality, X-InstructBLIP demonstrated state of the art performance ins zero-shot VizQiz while performing comparably to InstructBLIP across all tasks evaluated. For the video modality, X-InstructBLIP shows an improvement over InstructBLIP. Some results showed that a prefix may not substantially increase performance specifically for video modality. In some embodiments, a prefix may be not included relating to video modality inputs. For the audio modality, X-InstructBLIP displays comparable performance to its 3D encoder backbone in closed vocabulary classification settings applied using the loss ranking method. X-InstructBLIP also sets new standards in zero-shot performance for open generation settings, validated by its accuracy in identifying the correct ModelNet40 class within object descriptions when prompted with “Describe the 3D model.” X-InstructBLIP also shows improvements over the InstructBLIP baseline, which processes a single view rendering of the point cloud. Notably, X-InstructBLIP surpasses the PointLLM baseline by a notable margin.

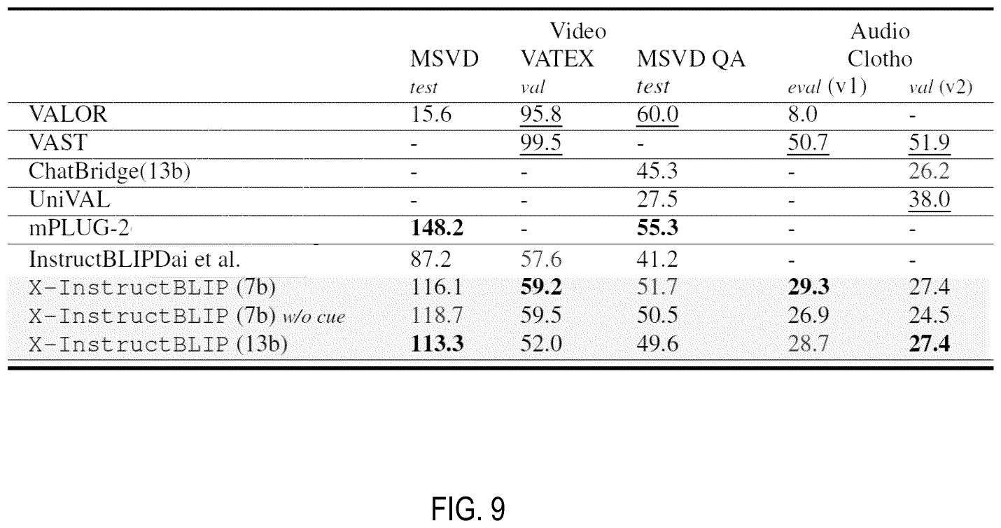

FIG. 8 illustrates image zero-zhot quantitative results. CIDEr score is reported for captioning tasks and accuracy for all other tasks. “7b” and “13b” indicate underlying Vicuna model size. “w/o cue” indicates that the model was trained and evaluated without specifying the type of modality provided in the query output tokens. This notation is followed in FIGS. 9-12.

FIG. 9 illustrates zero-shot quantitative results for audio or video individual modality to language tasks.

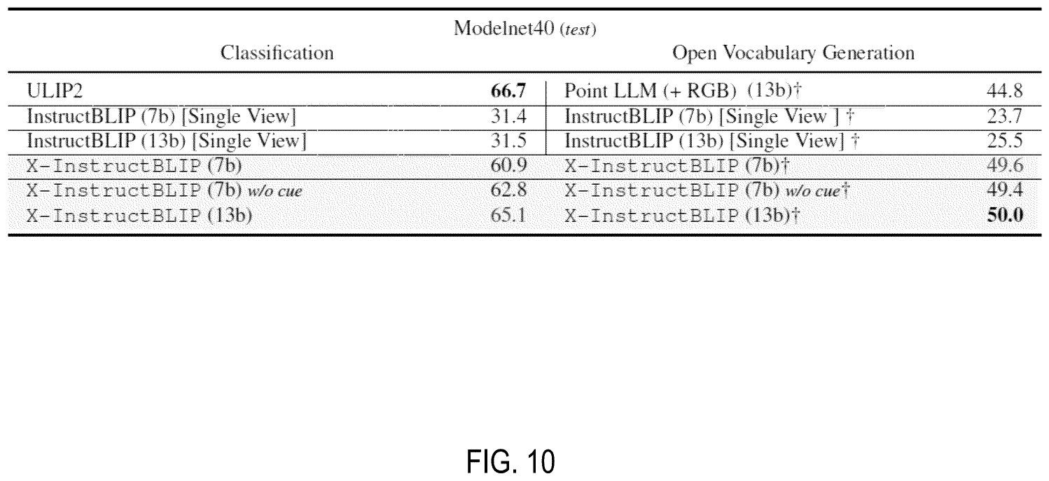

FIG. 10 illustrates 3D zero-shot quantitative results. The cross indicates open-vocabulary generation, as opposed to loss ranking classification.

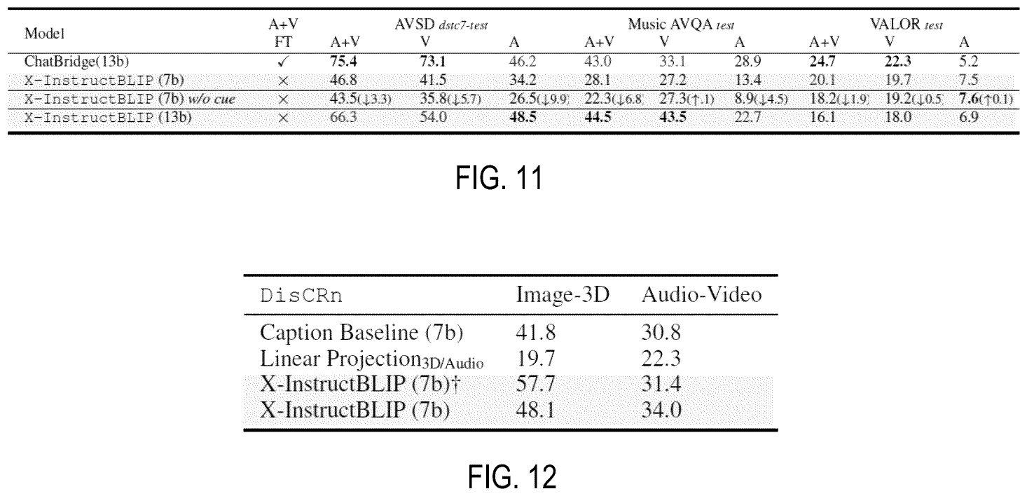

FIG. 11 illustrates emergent joint video (V)-audio (A) reasoning. Despite individual modality training, X-InstructBLIP achieves comparable performance with models trained on joint video-audio data. Notably, X-InstructBLIP (7b) excels in synergizing inputs, displaying an improvement in performance compared to utilizing a single modality, a phenomenon less accentuated in X-InstructBLIP (7b) ‘w/o cue’. Finally, X-InstructBLIP performs comparatively to ChatBridge, a Vicuna13b based cross-modal model finetuned on joint video-audio data. In the Music AVQA (Li et al., 2022b) X-InstructBLIP outperforms ChatBridge by using Vicuna 7b and Vicuna13b respectively.

FIG. 12 illustrates a summary of the results from the discriminatory reasoning experiments. It is evident that X-InstructBLIP surpasses the captioning baseline in both Image-3D and Audio-Video categories, despite the inherent challenges of the task both in terms of cross-modality and language based positional reasoning. A noteworthy observation is the doubling of performance on the Image-3D subset when description-based query outputs from the Q-Former are introduced, contrasted by a decline in the performance of the audio-video category. This discrepancy is likely attributed to the extensive training duration of the image Q-Former due to the large amount of data, allowing it to fine-tune its responsiveness to instructions, while the sequential Q-Formers reach convergence swiftly, subsequently experiencing a dip in performance and thus preserving more similar representation content across different instructions.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of generating a multi-modal task output for a text instruction relating to a plurality of inputs of different modalities, the method comprising:
receiving, via a data interface, a first input of a first modality, a second input of a second modality, and the text instruction relating to the first and the second inputs;
encoding, by a first multimodal encoder adapted for the first modality, the first input of the first modality into a first encoded representation conditioned on the text instruction;
encoding, by a second multimodal encoder adapted for the second modality, the second input of the second modality into a second encoded representation conditioned on the text instruction; and
generating, by a neural network based language model, the multi-modal task output based on an input combining the first encoded representation, the second encoded representation, and the text instruction.

2. The method of claim 1, wherein the first modality is one of: image, video, audio, or 3D.

3. The method of claim 2, wherein the second modality is a different modality than the first modality, and wherein the second modality is one of: image, video, audio, or 3D.

4. The method of claim 1, further comprising:
receiving, via the data interface, one or more additional inputs of one or more additional modalities; and
encoding, by respective multimodal encoders adapted for the one or more additional modalities, the one or more additional inputs of one or more additional modalities into additional encoded representations conditioned on the text instruction,
wherein the generating the multi-modal task output is further based on the additional encoded representations.

5. The method of claim 1, wherein the generating the multi-modal task output is further based on a first prefix indicating the first modality and a second prefix indicating the second modality.

6. The method of claim 1, further comprising:
encoding, by a modality-specific encoder, the first input into a first vector representation,
wherein the encoding the first input of the first modality into the first encoded representation includes generating, by the first multimodal encoder, the first encoded representation based on cross-attending the first vector representation to the text instruction.

7. The method of claim 6, wherein the encoding the first input of the first modality into the first encoded representation further includes cross-attending a plurality of vector queries to the text instruction.

8. A system for generating a multi-modal task output for a text instruction relating to a plurality of inputs of different modalities, the system comprising:
a memory that stores a neural network based language model and a plurality of processor executable instructions;
a data interface that receives a first input of a first modality, a second input of a second modality, and the text instruction relating to the first and the second inputs; and
one or more hardware processors that read and execute the plurality of processor-executable instructions from the memory to perform operations comprising:
encoding, by a first multimodal encoder adapted for the first modality, the first input of the first modality into a first encoded representation conditioned on the text instruction;
encoding, by a second multimodal encoder adapted for the second modality, the second input of the second modality into a second encoded representation conditioned on the text instruction; and
generating, by the neural network based language model, the multi-modal task output based on an input combining the first encoded representation, the second encoded representation, and the text instruction.

9. The system of claim 8, wherein the first modality is one of: image, video, audio, or 3D.

10. The system of claim 9, wherein the second modality is a different modality than the first modality, and wherein the second modality is one of: image, video, audio, or 3D.

11. The system of claim 8, the operations further comprising:
receiving, via the data interface, one or more additional inputs of one or more additional modalities; and
encoding, by respective multimodal encoders adapted for the one or more additional modalities, the one or more additional inputs of one or more additional modalities into additional encoded representations conditioned on the text instruction,
wherein the generating the multi-modal task output is further based on the additional encoded representations.

12. The system of claim 8, wherein the generating the multi-modal task output is further based on a first prefix indicating the first modality and a second prefix indicating the second modality.

13. The system of claim 8, the operations further comprising:
encoding, by a modality-specific encoder, the first input into a first vector representation,
wherein the encoding the first input of the first modality into the first encoded representation includes generating, by the first multimodal encoder, the first encoded representation based on cross-attending the first vector representation to the text instruction.

14. The system of claim 13, wherein the encoding the first input of the first modality into the first encoded representation further includes cross-attending a plurality of vector queries to the text instruction.

15. A non-transitory machine-readable medium comprising a plurality of machine-executable instructions which, when executed by one or more processors, are adapted to cause the one or more processors to perform operations comprising:
receiving, via a data interface, a first input of a first modality, a second input of a second modality, and a text instruction relating to the first and the second inputs;
encoding, by a first multimodal encoder adapted for the first modality, the first input of the first modality into a first encoded representation conditioned on the text instruction;
encoding, by a second multimodal encoder adapted for the second modality, the second input of the second modality into a second encoded representation conditioned on the text instruction; and
generating, by a neural network based language model, a multi-modal task output based on an input combining the first encoded representation, the second encoded representation, and the text instruction.

16. The non-transitory machine-readable medium of claim 15,
wherein the first modality is one of: image, video, audio, or 3D,
wherein the second modality is a different modality than the first modality, and
wherein the second modality is one of: image, video, audio, or 3D.

17. The non-transitory machine-readable medium of claim 15, the operations further comprising:
receiving, via the data interface, one or more additional inputs of one or more additional modalities; and
encoding, by respective multimodal encoders adapted for the one or more additional modalities, the one or more additional inputs of one or more additional modalities into additional encoded representations conditioned on the text instruction,
wherein the generating the multi-modal task output is further based on the additional encoded representations.

18. The non-transitory machine-readable medium of claim 15, wherein the generating the multi-modal task output is further based on a first prefix indicating the first modality and a second prefix indicating the second modality.

19. The non-transitory machine-readable medium of claim 15, the operations further comprising:
encoding, by a modality-specific encoder, the first input into a first vector representation,
wherein the encoding the first input of the first modality into the first encoded representation includes generating, by the first multimodal encoder, the first encoded representation based on cross-attending the first vector representation to the text instruction.

20. The non-transitory machine-readable medium of claim 19, wherein the encoding the first input of the first modality into the first encoded representation further includes cross-attending a plurality of vector queries to the text instruction.
